(19) United States
(12) Patent Application Publication
(10) Pub. No.: US 2017/0319011 A1
(43) Pub. Date: Nov. 9, 2017

(54) Fork Friend

(71) Applicant: John F. Barbee, Dublin, TX (US)

(72) Inventor: John F. Barbee, Dublin, TX (US)

(21) Appl. No.: 15/585,622

(22) Filed: May 3, 2017

Related U.S. Application Data
(60) Provisional application No. 62/332,062, filed on May 5, 2016.

(51) Int. Cl. A47J 43/28

(52) U.S. Cl. CPC A47J 43/288

(57) ABSTRACT

The Fork Friend is a domestic utensil designed to remove hot food from roasting forks without damaging the food, and minimize the risk of being burned during the removal of hot food. The Fork Friend is comprised of a flat, elongated rectangular shaped strap of metal, or thin, rigid, heat-resistant material, with notches cut and spaced so as to fit over the top of the tines on a roasting fork. By positioning the Fork Friend over the tines of the roasting fork and behind the food, the operator slides the Fork Friend along the tines, toward the end of the roasting fork, dislodging the food. The Fork Friend is unique in that it is an independent utensil which offers the controlled and safe removal of hot food from various styles, sizes, and shapes of roasting forks.

### CROSS REFERENCE TO RELATED APPLICATIONS

Provisional patent filed May 5, 2016—No. 62/332,062

### 37 CFR 1.78

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The Fork Friend is a handheld, domestic utensil designed to effectively, and safely remove food items from roasting forks. It offers a simple solution for problems experienced by people who roast food over a fire and attempt to dislodge hot food without burning their fingers or having to touch the food directly. The need for this utensil was discovered by John F Barbee (inventor) while volunteering to help with a children's benefit event, where he saw children and adults burning their fingers while trying to remove hotdogs from hot roasting forks. Traditional utensils such as forks or knives were ineffective in removing the hotdogs and other food items without breaking the food into undesirable pieces. Other instruments used succeeded in removing the food items from the roasting forks, but without control, often resulting in the food being dropped or flung onto the ground, or some other unsanitary place.

Upon building a prototype of the Fork Friend, the inventor discovered that the utensil does, in fact, provide the operator with an effective method of dislodging food items from roasting forks without damaging the food, and it effects the controlled deposit of food onto a designated surface without the operator ever having to touch the hot food.

Seeing as there are numerous outdoor activities (such as camping and picnicking) where roasting food over an open fire is traditionally part of the overall experience or event, there is a wide spectrum of people who would benefit from having a Fork Friend to effect safe and clean dislodging of food items from a roasting fork onto a desired surface.

### BRIEF SUMMARY OF THE INVENTION

The Fork Friend is an independent handheld utensil designed to remove food items from roasting forks. The size of the utensil provides for easy handling and use by adults and children. The specific placement and size of the notches cut into the strap of rigid material corresponds with the size and distance of the tines on commercial full sized and miniature roasting forks.

When used properly in conjunction with roasting forks, the Fork Friend provides the user with a safe method of effectively removing hot food items from a roasting fork without having direct physical contact with the hot food or the hot roasting fork, thereby minimizing the risk of burnt fingers or contaminated food.

### BRIEF DESCRIPTION OF THE SEVERAL VIEWS OF THE DRAWING

FIG. 1.

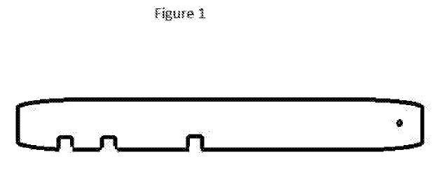

As shown in FIG. 1, a section of 16 gauge steel is cut in a flat, elongated rectangular shaped strap, 11 inches long and ¾ inch wide; with ¼ inch deep notches cut along one side; Notch A is positioned ½ inch from one end of the strap, Notch C is positioned ¾ inch from Notch A, and Notch B is positioned 2¾ inches from Notch A.

A small hanging hole is centered on the end opposite of Notch A, to facilitate balanced hanging of the device from a hook or nail when not in use.

### DETAILED DESCRIPTION OF THE INVENTION

The “Fork Friend” is a hand held utensil designed for the safe, effective, and clean removal of food items from roasting forks.

The Fork Friend is a flat, elongated rectangular shaped strap of thin metal or other smooth, durable, rigid, heat-resistant material; with notches cut along one side—the notches being spaced and sized so as to fit over the top of the tines on a roasting fork.

The Fork Friend can be made by cutting 16 gauge stainless steel into an 11 inch×¾ inch flat strap, then cutting ¼ inch by ¼ inch notches along one side of the 11 inch length—with the first notch (A) situated ½ inch from one end, and another notch (C) spaced ¾ inch from the center of notch A, and a third notch (B) spaced 2¾ inches from the center of notch A. When the notches are cut and spaced correctly, notches A and B will fit over the tines of full-sized roasting forks, and notches A and C will fit over the tines of miniature roasting forks, thus creating a single utensil that effects the safe, clean, and controlled removal of food items from multiple brands, sizes, and shapes of roasting forks.

The shape of the device and the notches can be made using either a handheld or programmable cutting torch. Once the cuts are made, it is recommended to round out the corners and smooth any sharp edges by using a grinder or some other tool that will remove metal burs and produce clean, smooth edges.

The Fork Friend is an independent utensil, however it is designed to accompany and pair with roasting forks. For best results, the operator holds the roasting fork firmly in one hand and the Fork Friend in the other hand. The Fork Friend is placed so that the notches set down over the top of the roasting fork tines, situated behind the food item(s) to be removed from the roasting fork. Applying slight downward pressure, the operator slides the notches along the top of the roasting fork tines, pushing the food toward the end of the roasting fork, dislodging the food item(s) onto a desired surface (plate, cutting board, etc).

The Fork Friend differs from previous designs of food removal tools. Previous designs are limited to meat forks with built in ejectors, limiting the effective dislodging of food to that particular utensil. The Fork Friend is an independent utensil that effectively and safely removes food items from a variety of roasting fork styles, sizes, and brands.

What is claimed is:

1. A hand held, independent domestic utensil which effects the safe, controlled, and clean removal of food items from a roasting fork, comprising:
A thin, elongated rectangular shaped strap of metal or other smooth, durable, rigid, heat-resistant material; and
with two notches cut into one side of the length of the utensil; and
with the two notches sized and spaced specifically to fit over the top of the tines of commercial full-sized roasting forks; and
which, when positioned with the notches set over the top of the roasting fork tines, situated behind the food item to be removed, and slid toward the end of the roasting fork, effectively dislodges food items from a roasting fork.

2. The hand held utensil of claim 1, wherein a third notch is cut and spaced close to the first notch; wherein
the first and third notches, being approximately ¾ inch apart, are cut and spaced so as to fit over the tines of commercial miniature roasting forks.
